(19) United States
(12) Patent Application Publication
(10) Pub. No.: US 2004/0241404 A1
(43) Pub. Date: Dec. 2, 2004

(54) Paper with holographic pattern and manufacture of it

(75) Inventor: Tsung-Ming Shiao, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 10/449,081

(22) Filed: Jun. 2, 2003

(51) Int. Cl. B32B 3/00

(52) U.S. Cl. 428/211.1

(57) ABSTRACT

A paper with a holographic pattern and manufacture of it uses a cold foil UV resin and UV illumination forming to reproduce a holographic pattern from a mother mold to a paper, and then, process a fabrication of a metalized holographic image to fix and protect the holographic pattern; or uses cold foil UV resin and UV illumination combining method to transfer a separating type metalized holographic image onto a paper. Thereby, a high quality paper with a holographic pattern can be obtained and can confirm to the requirement of quality/cost/environmental protection on the market to be used in counterfeit printing, decoration, packing and etc.

### BACKGROUND OF THE INVENTION

1. Field of the Invention

The present invention relates to a paper with a holographic pattern and more particularly to a method for producing a holographic pattern on a paper.

2. Description of Related Art

Taiwan patent no. 138,868 reveals a combination of a holographic sheet formation and a printing procedure. It is mainly to spread fluid type resin on one face of a paper, and a holographic pattern is molded on the resin by a plastic mold. And then, an electric beam is illuminated on the fluid type resin to harden it to form the holographic pattern. Because a dangerous electric beam illumination technology is used during manufacturing, specialists are needed to operate it so that mass manufacturing and production are impossible.

U.S. Pat. No. 5,939,177 reveals a holographically transferable image. It transfers a metallized holographic image spread with an adhesive layer onto a wrapping paper by a heating and pressing way so as to allow the wrapping paper to have the holographic image. However, it needs heating and pressing facilities during manufacturing, this increases production cost and slows down manufacturing speed.

The holographic pattern papers available on the market mainly are directly pressing paper, transferred paper and film covered paper. Among these, the quality of the directly pressing paper is bad; the production cost and manufacturing rate of the transferred paper are high and low respectively; the recycling handling of the film covered paper is difficult and the post-process of it is bad because it is made by sticking a plastic film on a paper. Therefore, there are not holographic pattern papers coped with quality, cost and environmental protection to be existed on the market even if the demand of holographic papers is so big.

### SUMMARY OF THE INVENTION

The main object of the present invention is to provide a paper with a holographic pattern and manufacture of it, enabling a paper with a holographic pattern has a better quality and production speed thereof can be raised.

Another object of the present invention is to provide a paper with a holographic pattern and manufacture of it, enabling various holographic patters on paper to have various metallic material colors to allow them to have more varieties.

Still another object of the present invention is to provide a paper with a holographic pattern and manufacture of it, the beautification and counterfeit proof of a paper product can be largely elevated, and recycling handling thereof is easier so that it is different from a general holographic plastic film sticker paper and can conform to environmental protection of post-recycling process.

### BRIEF DESCRIPTION OF THE DRAWINGS

The present invention can be more fully understood by reference to the following description and accompanying drawings, in which:

FIG. 1A to 1G are schematic views, showing manufacturing procedures of the first preferred embodiment according to the present invention;

FIG. 2A to 2C are schematic views, showing manufacturing procedures of the second preferred embodiment according to the present invention; and

FIG. 3A to 3D are schematic views, showing part of manufacturing procedures of the third preferred embodiment according to the present invention.

### DETAILED DESCRIPTION OF THE PREFERRED EMBODIMENTS

The present invention mainly uses a cold foil UV resin and UV illumination forming method to transfer a holographic pattern from a mother mold to a paper, and then, processes such as aluminum/zinc sulfide layers evaporation to fix and protect the holographic pattern. Or, uses a cold foil UV resin and UV illumination combination way to fabricate a holographic image with separating type metallization from a mother mold onto a paper. The mother mold is repeatedly used during manufacturing, this can lower production cost effectively. In the meantime, it can further confirm to the requirement on paper recycling because no plastic foils is existed in a product structure. The paper obtained from the method according to the present can conform to the requirement of the market on quality, cost and environmental protection, and can be applied on a variety of purposes such as counterfeiting printing, decoration and wrapping.

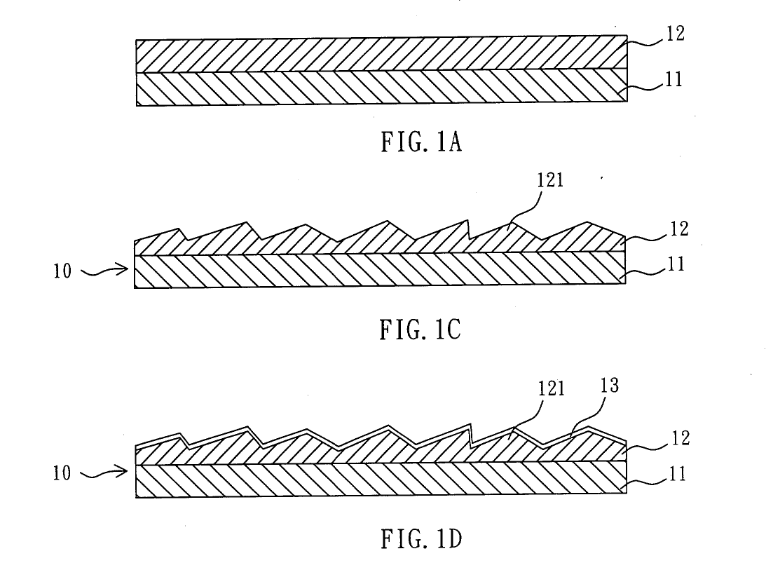

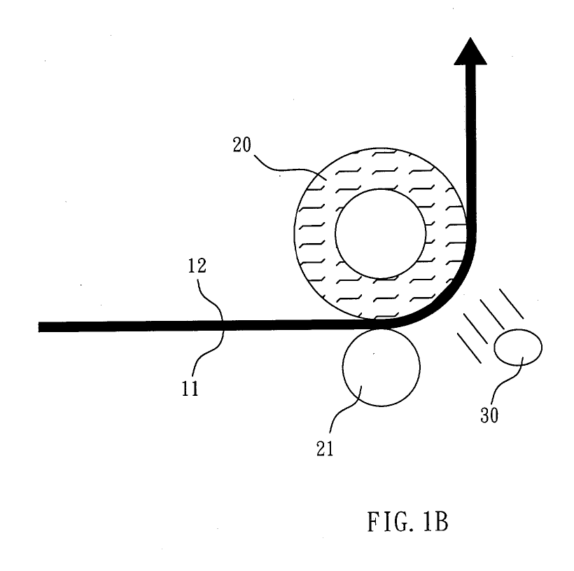

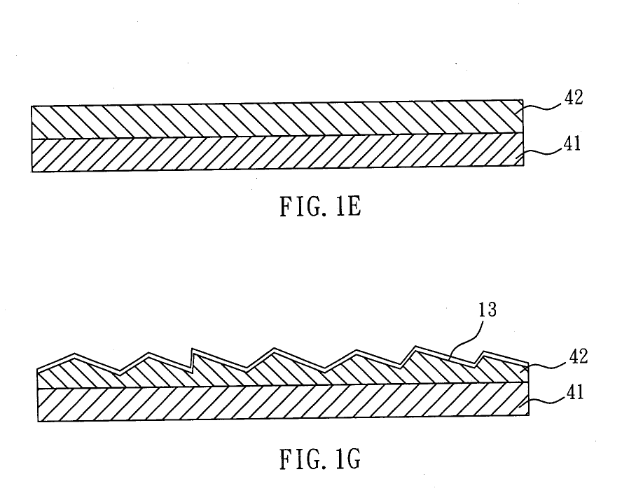

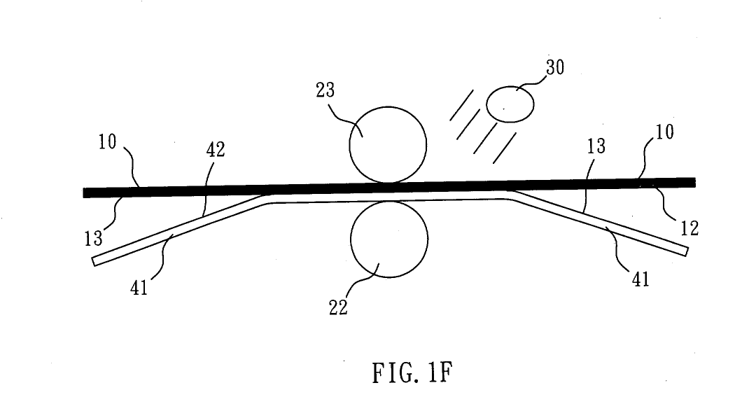

Please refer to FIG. 1A to 1G. The figures show a method according to the first preferred embodiment of the present invention. The method comprises the following steps:

(1) Spread a layer of UV resin film 12 with an uniform thickness approximately 1 to 10 μm on a plastic film 11 by using off-set printing or gravure printing technology, as shown in FIG. 1A. The plastic film 11 is chosen/from a plastic material such as PET, OPP, PVC or PC. The better material of the UV resin film 12 is cold foil UV resin.

(2) Stick the UV resin film 12 with a metal wheel 20 engraved with a holographic pattern and use a pressing wheel 21 to press the plastic film 11 from another side of the plastic film 11 toward the metal wheel 20, as shown in FIG. 1B, to cause the UV resin film 12 and the holographic pattern lines of the metal wheel 20 to stick each other closely. And then, use an UV lamp 30 to illuminate the UV resin film 12 that is stuck with the metal wheel 20 closely so as to harden the UV resin film 12 instantly. The UV resin film 12 is stuck closely with the chosen resin film 11 after the illumination of the UV lamp 30 owing to the good adhesion between the UV resin film 12 and the plastic film 11. This will make the hardened UV resin film 12 to separate from the metal wheel 30. Thereafter, the holographic pattern on the metal wheel 30 is duplicated on the UV resin film 12 so as to form a mother mold 10 with a holographic pattern 121, as shown in FIG. 1C.

(3) Process evaporation on the mother mold 10 with the holographic pattern 121 with metal materials such as aluminum/zinc sulfide to cause the appearance of the holographic pattern 121 to combine with a metalized holographic image 13, as shown in FIG. 1D. Owing to the bad adhesion between the hardened UV resin and metal evaporation-plating layer, therefore, the metalized holographic image 13 has the effect of the separating type.

(4) Spread a layer of a UV resin film 42 with an uniform thickness approximately 1 to 10 μm on a paper 42 by using off-set printing or gravure printing, as shown in FIG. 1E. The better material of the UV resin film 42 is cold foil UV resin. The paper can be chosen from one of papers with various different thicknesses (45/50/60/75/80/106/126 gsm).

(5) Press two pressing wheels 22 and 23 inward from the outsides of the mother mold 10 and the paper 41 respectively after the UV resin film 42 is stuck with the separating type metalized holographic image 13 outside the mother mold 10 to allow the UV resin film 42 to be stuck closely with the separating type metalized holographic image 13. And then, illuminate sufficiently with the UV lamp 30 from one side of the mother mold 10 to harden the UV resin film 42 instantly. And then, separate the mother mold 10 and the paper 41, as FIG. 1F shows. Therefore, the metalized holographic image 13 is closely stuck on the paper 41 after the UV lamp 30 illumination is completed so as to form a paper product with a holographic pattern, as shown in FIG. 1G. The mother mold 10 with the holographic pattern 121 can be used repeatedly after evaporation of Aluminum/Zinc sulfide plating layer in the step (3) is processed, it will overcome the difficulty in manufacturing process of the paper product with the holographic pattern after the evaporation of the Aluminum/Zinc Sulfide. Thereby, the successful rate can be elevated and the product cost can be lowered to the whole manufacturing process.

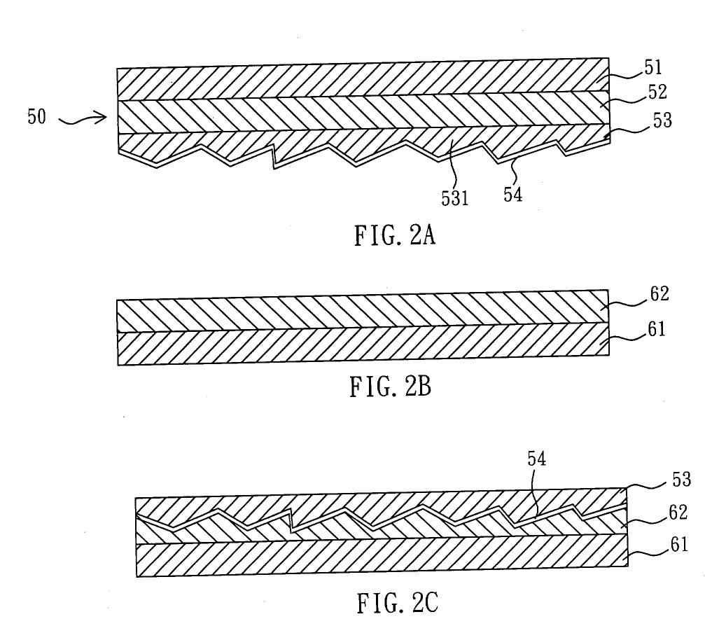

Please refer to FIG. 2A to 2C. The figures show a manufacturing method of the second preferred embodiment according to the present invention. A holographic pattern is chosen to manufacture a mother mold combined with a metalized holographic image by embossing way. This mother mold 50 comprises a carrier body layer 51, separating type layer 52 and embossing-used spreading resin layer 53 in a sequence. And, a metalized holographic image 54 plate from materials such as Aluminum/Zinc sulfide by evaporation is combined at the outside of a holographic pattern 531 of the embossing-used spreading resin layer 53. The carrier body layer 51 can be made from materials such as PET/OPP. The separating type layer 52 can be made from oleoresin. The embossing-used spreading resin layer 53 can be combined with a variety of color paints so as to allow the holographic pattern to have different colors.

Next, the step (4) and the step (5) of the first preferred embodiment mentioned above are processed. Stick a paper 61 spread with a layer of UV resin 62 with an uniform thickness 1 to 10 μm (shown in FIG. 2B) closely with a mother mold 50 combined with metalized holographic image 54 (shown in FIG. 2A). Thereafter, illuminate an UV lamp on the outside of the mother mold 50 to dry it; the UV resin 62 is soon hardened instantly. It is easy to separate carrier body layer 51 and the spreading resin layer 53 from the separating type layer 52 so as to allow the spreading resin layer 53 and the metalized holographic image 54 are closely stuck on the paper 61 after the illumination of the UV lamp is completed, owing to the good adhesion ability of the UV resin 62 to both of the paper 61 and the substrate component of the metalized holographic image 54 so as to form a paper product with a holographic pattern, as FIG. 2C shows.

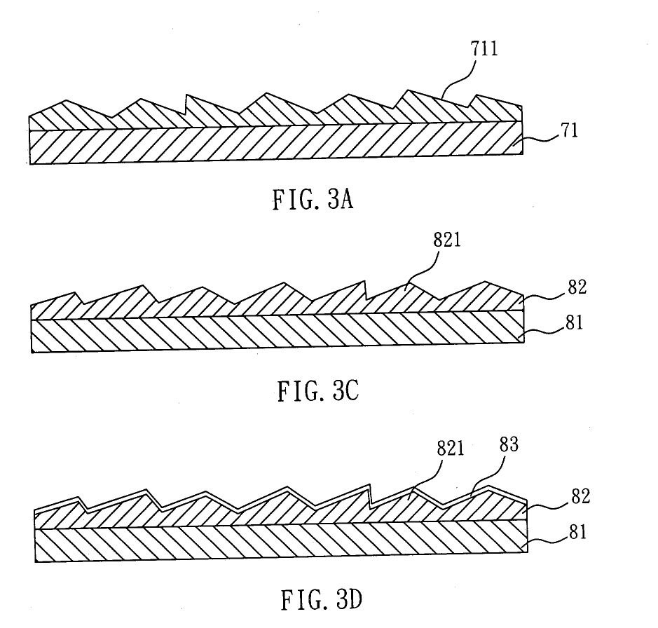

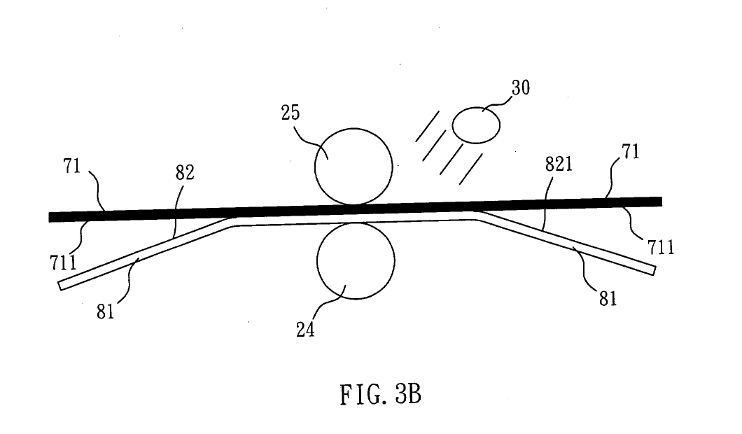

Please refer to FIG. 3A to 3D. The figures show a method of the third preferred embodiment according to the present invention. The method comprises the following steps:

(1) Spread a layer of UV resin film with an uniform thickness approximately 1 to 10 pm on a paper by using off-set printing or gravure printing technology. The better material of the UV resin film is cold foil UV resin.

(2) Stick the UV resin film with a mother mold 71 engraved with a holographic pattern 711, as FIG. 3A shows. And then, press two pressing wheels 24 and 25 inward from the outsides of the mother mold 71 and a paper 81 so as to stick the UV resin film 82 closely with the holographic pattern 711 together. Furthermore, sufficiently illuminate one side of the mother mold 71 with the UV lamp 30 to cause the UV resin film 82 to harden instantly; the holographic pattern 711 on the mother mold 71 is duplicated on the UV resin film 82, and the UV resin 82 and the paper 81 is fixedly combined. Thereafter, separate the mother mold 71 and the paper 81, as FIG. 3B shows, to allow the paper 81 to have a holographic pattern 821 (shown in FIG. 3C). And, the mother mold 71 with the holographic pattern 711 can be used repeatedly.

(3) Process the paper 81 with the holographic pattern 821 with the evaporation of materials such as Aluminum/Zinc sulfide to combine the outside of the holographic pattern 821 with a metalized holographic image 83, as FIG. 3D shows, to form a paper product with a holographic pattern.

The UV resin and the UV lamp used in the present invention are all used in the current industry. They are not dangerous. A UV lamp illumination facility is much cheaper than an electric beam illumination and only needs a general operator instead of a certificated specialist to operate it and process a mass production so as to save the production cost largely and to make the price of a paper with a holographic pattern cheaper.

It is noted that paper with a holographic pattern and manufacture of it described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A paper with a holographic pattern, comprising a paper combined with a UV resin film, wherein said UV a holographic pattern thereon, the outside of said holographic pattern is combined with a metalized holographic image.

2. The paper according to claim 1, wherein said UV resin film is made from a cold foil UV resin.

3. The paper according to claim 2, wherein said metalized holographic image is formed from Aluminum/Zinc sulfide evaporated on the outside of said holographic pattern.

4. A manufacturing process for a paper with a holographic pattern, comprising the following steps:
(1) spreading an UV resin film on a paper;
(2) sticking said UV resin film tightly with a mother mold combined with a separating type metalized holographic image;
(3) illuminating said UV resin film stuck tightly with said metalized holographic image from one side of said mother mold by an UV lamp to harden said UV resin film instantly and to stick tightly with said metalized holographic image and said paper respectively; and
(4) separating said metalized holographic image from said mother mold and transferring said metalized holographic image onto said paper.

5. The method according to claim 4, wherein said UV resin film is made from cold foil UV resin.

6. The method according to claim 4, where in a manufacturing method combining said mother mold and with a separating type metalized holographic image comprises the following steps:
(a) spread a UV resin film on to another plastic film;
(b) stick said another UV resin film tightly with a metal wheel engraved with a holographic laser pattern;
(c) harden said another UV resin film instantly by using an UV lamp to illuminate said UV resin film tightly stuck with said metal wheel;
(d) separate said hardened another UV resin film from said metal wheel, said holographic pattern on said metal wheel is duplicated onto said UV resin film to allow said plastic film to be a mother mold with a holographic pattern;
(e) evaporate one side of said mother mold having said holographic pattern with metal material to form said metalized holographic pattern, wherein said mother mold can be used repeatedly.

7. The method according to claim 4, wherein said mother mold consists of a carrier layer, separating layer and embossing-used spreading resin layer in sequence; the outside of said pressing-use spread resin layer is combined with said metalized holographic image.

8. The method according to claim 7, wherein said embossing-used spreading resin layer is combined with color paint.

9. The method according to claim 8, wherein the holographic patterns of said embossing-used spreading resin layer and said metalized holographic image are formed by means of embossing.

10. A method for manufacturing a paper with a holographic pattern, comprising the following steps:
(1) spreading an UV resin film on to a paper;
(2) sticking said UV resin film with a mother mold engraved with a holographic pattern, and pressing two press wheels inward from the outsides of said mother mold and said paper to stick said UV resin film and said holographic pattern closely together; and then, illuminating one side of said mother mold with an UV lamp to harden said UV resin film instantly; said holographic pattern on said mother mold being duplicated onto said UV resin film and said UV resin being stuck with said paper firmly; and then, separating said mother mold and said paper; wherein said mother mold can be used repeatedly;
(3) evaporating said paper with said holographic pattern with metal material to allow the outside of said holographic pattern to form a metalized holographic image.
